(19) United States
(12) Patent Application Publication
(10) Pub. No.: US 2021/0091552 A1
(43) Pub. Date: Mar. 25, 2021

(54) ELECTRICAL BOX SPACERS

(71) Applicant: Damen Reynolds, Lebanon, TN (US)

(72) Inventor: Damen Reynolds, Lebanon, TN (US)

(21) Appl. No.: 16/576,342

(22) Filed: Sep. 19, 2019

(51) Int. Cl. H02G 3/12; H01R 13/74

(52) U.S. Cl. CPC H02G 3/121; H01R 24/76; H01R 13/748

(57) ABSTRACT

A system for filling a gap between an electrical box and a wall so an electrical outlet connected to the electrical box lies substantially flush with the wall, the system comprises: a first spacer being sized and shaped in length and width to substantially match the length and width of the electrical box; and at least two connectors of sufficient length to connect the electrical outlet and the first spacer to the electrical box through two electrical outlet openings, the two first spacer openings and the two openings in the electrical box.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of electrical box devices and more specifically relates to a system for filling a gap between an electrical box and a wall so an electrical outlet connected to the electrical box lies substantially flush with the wall.

### 2. Description of the Related Art

A new tile accent on a wall can make any room look great, but it also creates gaps between the outlet and covers that can quickly ruin a remodel. In fact, electrical outlets can become misaligned and sunken whenever something gets added to the existing sheetrock or wall, and just using longer screws or bending tabs to make up the difference can leave the outlet wobbly and unstable. Therefore, a need exits for an easy to fill in the gap between the current working electrical box and the newly created wall or tiled surface, for a perfectly flush outlet every time thereby permitting the right thickness for a clean, professional result every time.

Various attempts have been made to solve problems found in electrical box device art. Among these are found in: U.S. Pat. No. 8,987,593 to Korcz et al.; U.S. Pat. No. 6,953,894 to Ungerman et al.; U.S. Pat. No. 7,053,301 to Steven J. Johnson; U.S. Pat. No. 8,371,465 to Dennis J. Denier; and U.S. Pub. No. 2010/0089912 to Wegner et al. This prior art is representative of electrical box extender device.

Ideally, a system for filling a gap between an electrical box and a wall should be user-friendly and safe in-use and yet would operate reliably and be manufactured at a modest expense. Thus, a need exists for a system for filling a gap between an electrical box and a wall so an electrical outlet connected to the electrical box lies substantially flush with the wall and to avoid the above-mentioned problems.

### BRIEF SUMMARY OF THE INVENTION

In view of the foregoing disadvantages inherent in the known electrical box device art, the present invention provides a novel System for Filling a Gap Between an Electrical Box and a Wall (Entitled Electrical Box Spacers). The general purpose of the present invention, which will be described subsequently in greater detail is to provide a system for filling a gap between an electrical box and a wall so an electrical outlet connected to the electrical box lies substantially flush with the wall.

A system for filling a gap between an electrical box and a wall so an electrical outlet connected to the electrical box lies substantially flush with the wall, the system comprises: a first spacer being sized and shaped in length and width to substantially match the length and width of the electrical box; and at least two connectors of sufficient length to connect the electrical outlet and the first spacer to the electrical box through two electrical outlet openings, the two first spacer openings and the two openings in the electrical box.

The first spacer having a first depth dimension of approximately ½-inch. The first spacer having a first spacer internal opening to encompass the electrical outlet. The first spacer has at least two first spacer openings matching respectively two openings in the electrical box for connection of at least the first spacer to the electrical box. Whereby the electrical outlet may be mounted to lie substantially flush with the wall by using the two connectors to connect the electrical outlet and the first spacer to the electrical box. Wherein the at least two connectors comprise screws.

The system further comprising: a second spacer being sized and shaped in length and width to substantially match the length and width of the electrical box, and at least two connectors of sufficient length to connect the electrical outlet and the second spacer to the electrical box through the two electrical outlet openings, the two second spacer openings and the two openings in the electrical box. The second spacer having a second depth dimension of approximately 3/8-inch. The second spacer having a second spacer internal opening to encompass the electrical outlet. The second spacer having at least two second spacer openings matching respectively the two openings in the electrical box for connection of at least the second spacer to the electrical box.

Wherein the first spacer and the second spacer are sized substantially the same in length and width. Wherein the at least two connectors are of sufficient length to connect the electrical outlet, the first spacer, and the second spacer to the electrical box through the two electrical outlet openings, the two first spacer openings, the two second spacer openings, and the two openings in the electrical box. Wherein the second depth dimension of the second spacer is less than the first depth dimension of the first spacer.

The system further comprising: a third spacer being sized and shaped in length and width to substantially match the length and width of the electrical box, and the at least two connectors being of sufficient length to connect the electrical outlet and the third spacer to the electrical box through the two electrical outlet openings, the two third spacer openings and the two openings in the electrical box. The third spacer having a third depth dimension of approximately ⅛-inch. The third spacer having a third spacer internal opening to encompass the electrical outlet. The third spacer having at least two third spacer openings matching respectively the two openings in the electrical box for connection of at least the third spacer to the electrical box. The at least two connectors being of sufficient length to connect the electrical outlet and the third spacer to the electrical box through the two electrical outlet openings, the two third spacer openings and the two openings in the electrical box.

Wherein the first spacer, the second spacer, and the third spacer are sized substantially the same in length and width. Wherein the at least two connectors are of sufficient length to connect the electrical outlet, the first spacer, the second spacer, and the third spacer to the electrical box through the two electrical outlet openings, the two first spacer openings, the two second spacer openings, the two third spacer openings, and the two openings in the electrical box. Wherein the third depth dimension of the third spacer is less than the second depth dimension of the second spacer.

The present invention holds significant improvements and serves as a System for Filling a Gap Between an Electrical Box and a Wall (Entitled Electrical Box Spacers). For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a System for Filling a Gap Between an Electrical Box and a Wall (Entitled Electrical Box Spacers). constructed and operative according to the teachings of the present invention.

FIG. 1 shows a perspective view illustrating a System for Filling a Gap Between an Electrical Box and a Wall according to an embodiment of the present invention.

FIG. 2 is a perspective view illustrating the System for Filling a Gap Between an Electrical Box and a Wall in a fully assembled condition ready for use according to an embodiment of the present invention of FIG. 1.

FIG. 3 is a perspective view illustrating an electrical outlet connected to a spacer via at least two connectors to the electrical box through two electrical outlet openings of the electrical box System for Filling a Gap Between an Electrical Box and a Wall according to an embodiment of the present invention of FIG. 1.

FIG. 4 is a perspective view illustrating the first spacer being inserted into an electrical box of the System for Filling a Gap Between an Electrical Box and a Wall in a fully assembled condition ready for use according to an embodiment of the present invention of FIG. 1.

FIG. 5 is a perspective view illustrating the electrical outlet being inserted into the electrical box after the spacer has been inserted into the electrical box of the System for Filling a Gap Between an Electrical Box and a Wall in a fully assembled condition ready for use according to an embodiment of the present invention of FIG. 1.

FIG. 6 is a perspective view illustrating a kit of the System for Filling a Gap Between an Electrical Box and a Wall in a fully assembled condition ready for use according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to an electrical box device and more particularly to a system for filling a gap between an electrical box and a wall so an electrical outlet connected to the electrical box lies substantially flush with the wall (Entitled Electrical Box Spacers)

Generally speaking, the Electrical Box Spacers comprising a novel product offering consumers a practical solution to the aforementioned challenges. As the name implies, the Electrical Box Spacers comprises a specially designed spacer that may fill the gap between an existing electrical box and the outside flush portion of a newly created wall or tiled surface for a perfectly flush outlet every time. Plus, unlike larger box extenders, the Smart Fill Spacers can be stacked and combined to exactly the right thickness for a clean, professional result.

Easy to Use and Packed with Features and Benefits:
Creates a solid surface for securing the outlet cover when the electrical box is recessed
Available in standard ¼-inch black polypropylene, ⅜-inch gray polypropylene, and ½-inch black polypropylene sizes
Can be stacked in combination to get the perfect spacing
Includes longer machine screws to accommodate the spacer between the sockets and electrical box

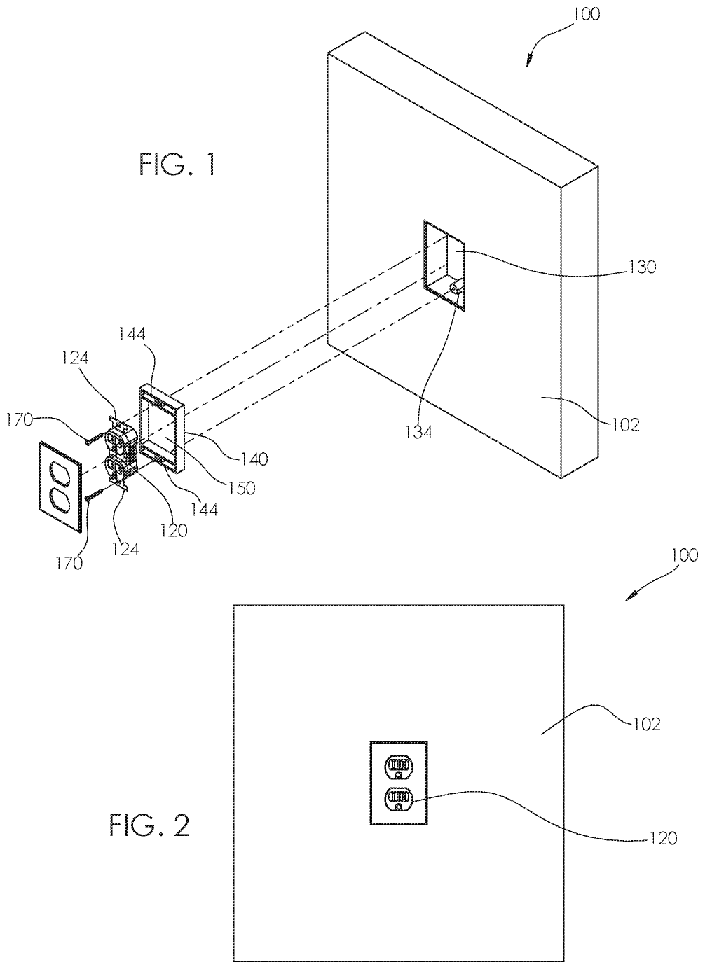

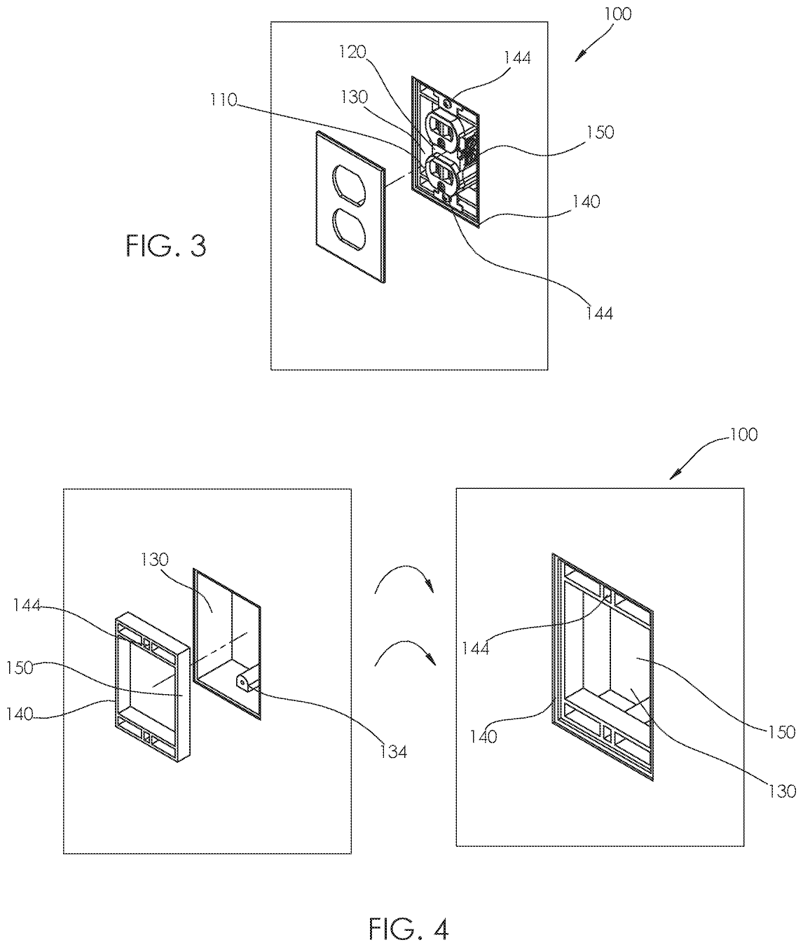

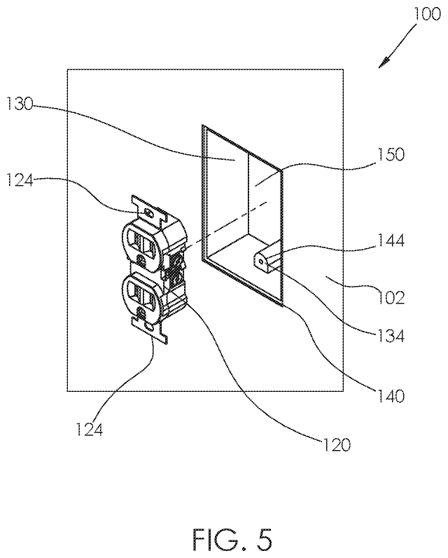

Referring to the drawings by numerals of reference there is shown in FIGS. 1-5, perspective views illustrating System 100 for filling a gap between electrical box 130 and wall 102 so electrical outlet 120 connected to electrical box 130 lies substantially flush with wall 102 according to an embodiment of the present invention.

System 100 for filling a gap between electrical box 130 and wall 102 so electrical outlet 120 connected to electrical box 130 lies substantially flush with wall 102, system 100 comprises: first spacer 140 being sized and shaped in length and width to substantially match the length and width of electrical box 130; and at least two connectors 170 of sufficient length to connect electrical outlet 120 and first spacer 140 to electrical box 130 through two electrical outlet openings 124, two first spacer openings 144 and two openings 134 in electrical box 130.

First spacer 140 having a first depth dimension of approximately ½-inch. First spacer 140 has a first spacer internal opening 150 to encompass electrical outlet 120. First spacer 140 has at least two first spacer openings 144 matching respectively two openings 134 in electrical box 130 for connection of at least first spacer 140 to electrical box 130. Whereby electrical outlet 120 may be mounted to lie substantially flush with wall 102 by using two connectors 170 to connect electrical outlet 120 and first spacer 140 to electrical box 130. Wherein at least two connectors 170 comprise screws.

System 100 further comprises: second spacer 610 being sized and shaped in length and width to substantially match the length and width of electrical box 130, and at least two connectors 170 of sufficient length to connect electrical outlet 120 and second spacer 610 to electrical box 130 through two electrical outlet openings 124, two second spacer openings 620 and two openings 134 in electrical box 130. Second spacer 610 having a second depth dimension of approximately 3/8-inch. Second spacer 610 has second spacer internal opening 614 to encompass electrical outlet 120. Second spacer 610 has at least two second spacer openings 620 matching respectively two openings 134 in electrical box 130 for connection of at least second spacer 610 to electrical box 130.

Wherein first spacer 140 and second spacer 610 are sized substantially the same in length and width. Wherein at least two connectors 170 are of sufficient length to connect electrical outlet 120, first spacer 140, and second spacer 610 to electrical box 120 through two electrical outlet openings 124, the two first spacer openings 144, two second spacer openings 620, and two openings 134 in electrical box 130. Wherein the second depth dimension of second spacer 610 is less than the first depth dimension of first spacer 140.

System 100 further comprises: third spacer 650 being sized and shaped in length and width to substantially match the length and width of electrical box 130, and the at least two connectors 170 being of sufficient length to connect electrical outlet 120 and third spacer 650 the electrical box 130 through two electrical outlet openings 124, two third spacer openings 660 and two openings 134 in electrical box 130. Third spacer 650 had a third depth dimension of approximately 1/8-inch. Third spacer 650 has third spacer internal opening 654 to encompass electrical outlet 120. Third spacer 650 has at least two third spacer openings 660 matching respectively two openings 134 in electrical box 130 for connection of at least third spacer 650 to electrical box 130. At least two connectors 170 being of sufficient length to connect electrical outlet 120 and third spacer 650 to electrical box 130 through two electrical outlet openings 124, two third spacer openings 660 and two openings 134 in electrical box 130.

Wherein first spacer 140, second spacer 610, and third spacer 650 are sized substantially the same in length and width. Wherein at least two connectors 170 are of sufficient length to connect electrical outlet 120, first spacer 140, second spacer 610, and third spacer 650 to electrical box 130 through two electrical outlet openings 124, two first spacer openings 144, two second spacer openings 620, two third spacer openings 660, and two openings 134 in electrical box 130. Wherein the third depth dimension of third spacer 650 is less than the second depth dimension of second spacer 610.

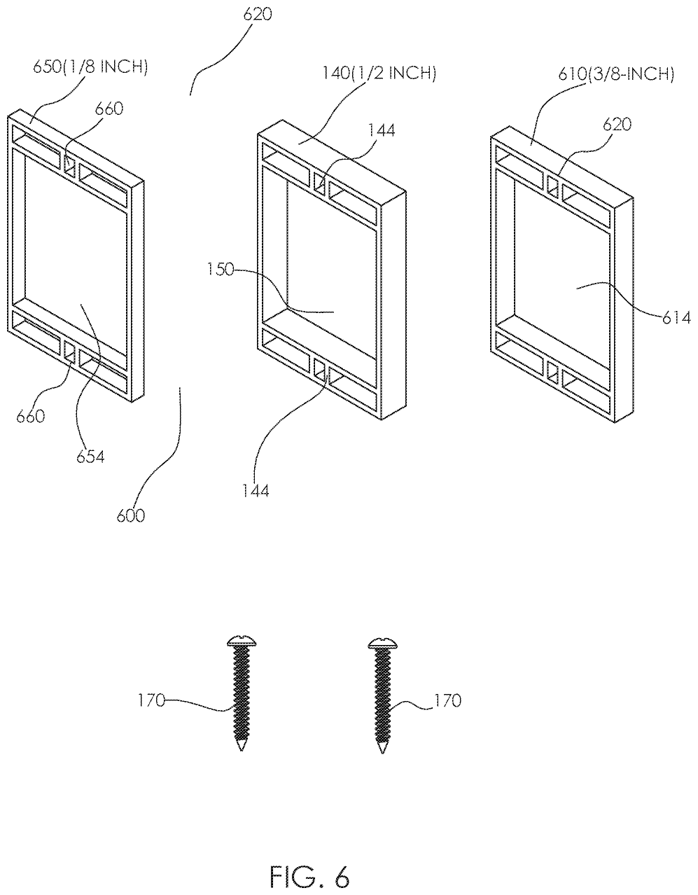

Referring now to FIG. 6, illustrating a perspective view of kit 600 for filling a gap between electrical box 130 and wall 102 so electrical outlet 120 connected to electrical box 130 lies substantially flush with wall 102, according to an embodiment of the present invention.

Kit 600 is also disclosed for filling a gap between an electrical box 130 and wall 102 so electrical outlet 120 connected to electrical box 130 lies substantially flush with wall 102. Kit 600 may include: first spacer 140 having a first depth dimension of approximately ½-inch; second spacer 610 having a second depth dimension of approximately ⅜-inch; third spacer 650 having a third depth dimension of approximately ⅛-inch; and at least two connectors 170 of sufficient length to connect electrical outlet 120 and spacer (first space140, second spacer 610, or third spacer 650) to electrical box 130 through two electrical outlet openings 124, spacer openings (first spacer opening 144, second spacer openings 620, or third spacer openings 650) and the two openings 134 in electrical box 130.

Kit 600 has instructions such that functional relationships are detailed in relation to the structure of the invention (such that the invention can be used, maintained, or the like in a preferred manner). The kit may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The present invention holds significant improvements and serves as a System for Filling a Gap Between an Electrical Box and a Wall (Entitled Electrical Box Spacers). For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A kit for filling a gap between an electrical box and a wall in which the electrical box is disposed so an electrical outlet connected to the electrical box lies substantially flush with the wall, the kit comprising:
a first spacer being sized and shaped in length and width to substantially match the length and width of the electrical box,
the first spacer having a first depth dimension,
the first spacer having a first spacer internal opening to encompass the electrical outlet, and
the first spacer having at least two first spacer openings matching respectively two openings in the electrical box for connection of at least the first spacer to the electrical box;
at least two connectors of sufficient length to connect the electrical outlet and the first spacer to the electrical box through two electrical outlet openings, the two first spacer openings and the two openings in the electrical box,
whereby the electrical outlet may be mounted to lie substantially flush with the wall by using the two connectors to connect the electrical outlet and the first spacer to the electrical box.

2. The kit of claim 2, wherein the at least two connectors comprise screws.

3. The kit of claim 1, further comprising:
a second spacer being sized and shaped in length and width to substantially match the length and width of the electrical box,
the second spacer having a second depth dimension,
the second spacer having a second spacer internal opening to encompass the electrical outlet, and
the second spacer having at least two second spacer openings matching respectively the two openings in the electrical box for connection of at least the second spacer to the electrical box;
the at least two connectors of sufficient length to connect the electrical outlet and the second spacer to the electrical box through the two electrical outlet openings, the two second spacer openings and the two openings in the electrical box.

4. The kit of claim 3, wherein the first spacer and the second spacer are sized substantially the same in length and width; and
wherein the at least two connectors are of sufficient length to connect the electrical outlet, the first spacer, and the second spacer to the electrical box through the two electrical outlet openings, the two first spacer openings, the two second spacer openings, and the two openings in the electrical box.

5. The kit of claim 4, wherein the second depth dimension of the second spacer is less than the first depth dimension of the first spacer.

6. The kit of claim 3, further comprising:
a third spacer being sized and shaped in length and width to substantially match the length and width of the electrical box,
the third spacer having a third depth dimension,
the third spacer having a third spacer internal opening to encompass the electrical outlet, and
the third spacer having at least two third spacer openings matching respectively the two openings in the electrical box for connection of at least the third spacer to the electrical box;
the at least two connectors being of sufficient length to connect the electrical outlet and the third spacer to the electrical box through the two electrical outlet openings, the two third spacer openings and the two openings in the electrical box.

7. The kit of claim 6, wherein the first spacer, the second spacer, and the third spacer are sized substantially the same in length and width; and
wherein the at least two connectors are of sufficient length to connect the electrical outlet, the first spacer, the second spacer, and the third spacer to the electrical box through the two electrical outlet openings, the two first spacer openings, the two second spacer openings, the two third spacer openings, and the two openings in the electrical box.

8. The kit of claim 4, wherein the third depth dimension of the third spacer is less than the second depth dimension of the second spacer.

9. A system for filling a gap between an electrical box and a wall so an electrical outlet connected to the electrical box lies substantially flush with the wall, the system comprising:
a first spacer sized and shaped to substantially match the electrical box,
the first spacer having a first depth dimension,
the first spacer having a first spacer internal opening to encompass the electrical outlet, and
the first spacer having at least two first spacer openings located to match respectively two openings in the electrical box for connection of at least the first spacer to the electrical box, and
the two first spacer openings also located to match respectively two openings in the electrical outlet for connection of the electrical outlet to the first spacer;
at least two connectors of sufficient length to connect the electrical outlet and the first spacer to the electrical box through the two electrical outlet openings, the two first spacer openings and the two openings in the electrical box,
whereby the electrical outlet may be mounted to lie substantially flush with the wall by using the connectors to connect the electrical outlet and the first spacer to the electrical box.

10. The system of claim 9, wherein the at least two connectors comprise screws.

11. The system of claim 9, further comprising:
a second spacer being sized and shaped in length and width to substantially match the length and width of the electrical box,
the second spacer having a second depth dimension,
the second spacer having a second spacer internal opening to encompass the electrical outlet, and
the second spacer having at least two second spacer openings matching respectively the two openings in the electrical box for connection of at least the second spacer to the electrical box, and
the two second spacer openings also located to match respectively the two openings in the electrical outlet for connection of the electrical outlet to the second spacer;
the at least two connectors being of sufficient length to connect the electrical outlet and the second spacer to the electrical box through the two openings in the electrical outlet, the two second spacer openings and the two openings in the electrical box,
whereby the electrical outlet may be mounted to lie substantially flush with the wall by using the screws to connect the electrical outlet and the second spacer to the electrical box.

12. The system of claim 11, wherein the at least two connectors being of sufficient length to connect the electrical outlet, the first spacer, and the second spacer to the electrical box through the two openings in the electrical outlet, the two first spacer openings, the two second spacer openings, and the two openings in the electrical box,
whereby the electrical outlet may be mounted to lie substantially flush with the wall by using the connectors to connect the electrical outlet, the first spacer, and the second spacer to the electrical box.

13. The system of claim 11, further comprising:
a third spacer being sized and shaped in length and width to substantially match the length and width of the electrical box,
the third spacer having a third depth dimension,
the third spacer having a third spacer internal opening to encompass the electrical outlet, and
the third spacer having at least two third spacer openings matching respectively the two openings in the electrical box for connection of at least the third spacer to the electrical box, and
the two third spacer openings also located to match respectively the two openings in the electrical outlet for connection of the electrical outlet to the third spacer;
the at least two connectors being of sufficient length to connect the electrical outlet and the third spacer to the electrical box through the two openings in the electrical outlet, the two third spacer openings and the two openings in the electrical box,
whereby the electrical outlet may be mounted to lie substantially flat with the wall by using the connectors to connect the electrical outlet and the third spacer to the electrical box.

14. The system of claim 13, wherein the at least two connectors being of sufficient length to connect the electrical outlet, the second spacer and the third spacer to the electrical box through the two openings in the electrical outlet, the second spacer openings, the two third spacer openings, and the two openings in the electrical box,
whereby the electrical outlet may be mounted to lie substantially flat with the wall by using the screws to connect the electrical outlet, the second spacer and the third spacer to the electrical box.

15. The system of claim 13, wherein the at least two connectors being of sufficient length to connect the electrical outlet, the first spacer, the second spacer, and the third spacer to the electrical box through the two openings in the electrical outlet, the first spacer openings, the two second spacer openings, the two third spacer openings and the two openings in the electrical box,
whereby the electrical outlet may be mounted to lie substantially flat with the wall by using the screws to connect the electrical outlet, the first spacer, second spacer and the third spacer to the electrical box.

16. A device for filling a gap between an original wall having an electrical box with outer edges of the electrical box being substantially flush with the original wall and a new wall disposed on top of the original wall so as to allow an electric outlet to lie flush with the new wall while connected to the electrical box lying flush with the original wall, the device comprising:
a spacer shaped generally to match an opening in the original wall for the electrical box,
the spacer having a depth dimension substantially matching depth of the new wall,
the spacer having an opening to encompass the electrical outlet,
the spacer being connected to the electrical outlet, and
the spacer being disposed between the new wall and the original wall,
whereby the electrical outlet is mounted in the spacer to lie substantially flat with the new wall and is connected to the electrical box.

17. The device of claim 16, wherein the spacer is generally rectangular in length and width.

18. The device of claim 16, wherein the spacer is connected to the electrical outlet by a connector.

19. The device of claim 18, wherein the connector connects the spacer to the electrical box.

20. The device of claim 19, wherein the connector comprises at least a screw.
